(19) United States
(12) Patent Application Publication
(10) Pub. No.: US 2019/0022883 A1
(43) Pub. Date: Jan. 24, 2019

(54) MAGAZINE TYPE SHAVER

(71) Applicant: Xiangrong Ren, Wenzhou (CN)

(72) Inventor: Xiangrong Ren, Wenzhou (CN)

(21) Appl. No.: 16/069,499

(22) PCT Filed: Jan. 15, 2016
(86) PCT No.: PCT/CN2016/071009

§ 371 Date: Jul. 11, 2018

(51) Int. Cl. B26B 21/24; B26B 21/52; B26B 21/40

(52) U.S. Cl. CPC B26B 21/24; B26B 21/4037; B26B 21/521

(57) ABSTRACT

A magazine type shaver includes a shaver head assembly, a magazine body for holding, and an elastic element. The shaver head assembly includes a first shaver head and a second shaver head which are interchangeable. The magazine body is a hollow structure and forms a receiving chamber with an opening for receiving the shaver head assembly. The magazine body is provided with a connection part selectively assembled with the first shaver head or the second shaver head. The elastic element is accommodated in the receiving chamber and urges the shaver heads to slide towards the opening. Since the shaver heads are accommodated in the receiving chamber, and urged to slide to the opening under an action of the elastic element, it is very convenient for the shaver heads to be stored in or taken out from the magazine body. And it is convenient for users to carry and use it.

### FIELD OF THE INVENTION

The present invention relates to technical field of shaving, and more particularly to a magazine type shaver.

### BACKGROUND OF THE INVENTION

With improvement of the economy and the society, abounding consumables are offered to people to satisfy people's demand, thereby improving people's standard or living. While razors are one of these consumables.

Currently, the razors have two types including electric shavers and manual shavers. Regarding the manual shavers, as it has advantages of clean shave and no power source, thus the manual shaver takes up a large percentage of the market share.

The current manual shaver mainly includes a handle, a shaver head and a linking structure between the handle and the shaver head. If the shaver head becomes blunt or is damaged, the old one is required to be removed, and is replaced by a new one. Thus, for traveling users, they must back up the new ones in their baggage for replacement.

However, the current manual shavers and the replaceable shaver heads are independent parts which are required to be packaged separately for traveling users, which is inconvenient and will be easily omitted. Furthermore, the structure of the manual shaver is not compact.

Therefore, there is a need for providing an improved hand-held shaver which has compact structure and clean look and is convenient to carry, to overcome the above-mentioned drawbacks.

### SUMMARY OF THE INVENTION

One objective of the present invention is to provide a magazine type shaver which has compact structure and clean look and is convenient to carry.

To achieve the above-mentioned objective, a magazine type shaver includes magazine type shaver includes a shaver head assembly, a magazine body for holding, and an elastic element. The shaver head assembly includes a first shaver head and a second shaver head which are interchangeable. The magazine body is a hollow structure which forms a receiving chamber with an opening for receiving the first shaver head and the second shaver head, and the magazine body is provided with a connection part selectively assembled with the first shaver head or the second shaver head. The elastic element is accommodated in the receiving chamber and urges the shaver heads received in receiving chamber to slide towards the opening.

Preferably, the magazine type shaver further includes a pushing plate accommodated in the receiving chamber; one end of the pushing plate contacts with the elastic element, and the other end of the pushing plate contacts with the shaver heads that are received in the receiving chamber.

Preferably, a plurality of the second shaver heads are provided and arranged along a lengthwise direction of the magazine body.

Preferably, the connection part is located at a top surface of the magazine body.

Preferably, the connection part includes a support arm extending from the top surface of the magazine body and an abutment arm that is elastic, the support arm is selectively assembled with the first shaver head or the second shaver head, and the abutment arm abuts on the first shaver head or the second shaver head that is assembled with the support arm.

Preferably, the support arm includes a curved first support arm and a curved second support arm spaced apart from each other, and the abutment arm is located between the first support arm and the second support arm.

Preferably, the opening is formed at a side wall of the magazine body.

Preferably, the receiving chamber penetrates a lower end of the magazine body and forms a cavity opening, the lower end of the magazine body is provided with a shielding cover to cover the cavity opening, and the shielding cover is further provided with a plug-in part inserted in the opening.

Preferably, a sealing strip is provided between the lower ends of the magazine body and the shielding cover, and the sealing strip seals a joint of the lower end of the magazine body and the shielding cover.

Preferably, the magazine type shaver further includes a protective case assembled on an upper end of the magazine body for covering the connection part, and the first shaver head or the second shaver head that is assembled with connection part, and a box structure is defined by the protective case and the magazine body.

To achieve the above-mentioned objective, a magazine type shaver includes a shaver head assembly, a magazine body for holding, and an elastic element. The shaver head assembly includes a first shaver head and a second shaver head which are interchangeable. The first shaver head and the second shaver head are provided with a pushing structure. The magazine body is a hollow structure which forms a receiving chamber with an opening for receiving the first shaver head or the second shaver head, and the magazine body is provided with a connection part selectively assembled with the first shaver head or the second shaver head. The elastic element is accommodated in the receiving chamber and urges the shaver heads received in receiving chamber to slide towards the opening, so the shaver head is capable of being slid out of the opening by pressing the pushing structure.

Preferably, the pushing structure is a rugged structure.

In comparison with the prior art, since the shaver heads are accommodated in the receiving chamber of the magazine body and urged to slide to the opening under an action of the elastic element, and the connection part is selectively assembled with the first shaver head or the second shaver head. Thus, the magazine body has compact structure and clean look. Further, the replaceable shaver head is accommodated in the magazine body, thus the replaceable shaver head is not easy to be omitted and is convenient to be carried. Furthermore, the shaver heads in the receiving chamber are urged to slide upwards due to the spring action of the elastic element, thus it's easy and convenient for user to expose the opening and then take out a replaceable shaver head from the receiving chamber.

### BRIEF DESCRIPTION OF THE DRAWINGS

The accompanying drawings facilitate an understanding of the various embodiments of this invention. In such drawings:

FIG. 1 is a perspective view of a magazine type shaver according to an embodiment of the present invention;

FIG. 2 is an exploded view of FIG. 1;

FIG. 3 is a further exploded view of FIG. 2;

FIG. 4 is a perspective view of a magazine type shaver from another angle according to the embodiment of the present invention;

FIG. 5 is an exploded view of FIG. 4;

FIG. 6 is a further exploded view of FIG. 5; and

FIG. 7 is a perspective view of a second shaver head according to the embodiment of the present invention.

### DETAILED DESCRIPTION OF ILLUSTRATED EMBODIMENTS

A distinct and full description of the technical solution of the present invention will follow by combining with the accompanying drawings.

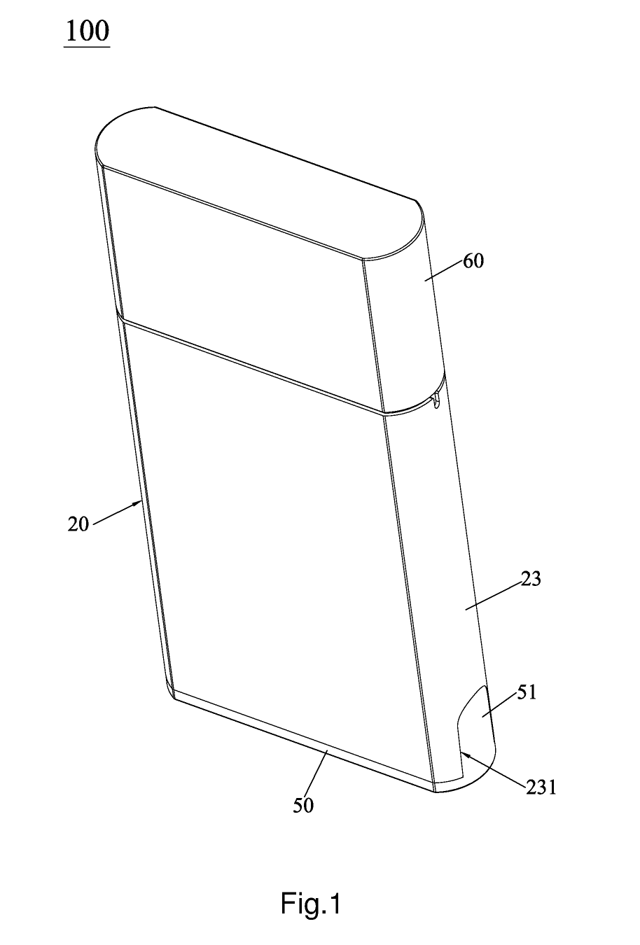

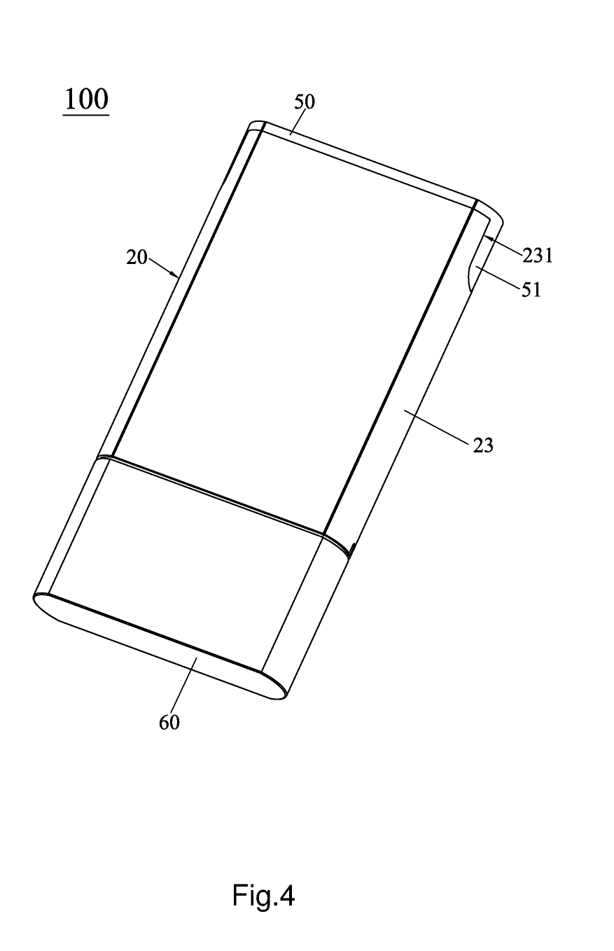

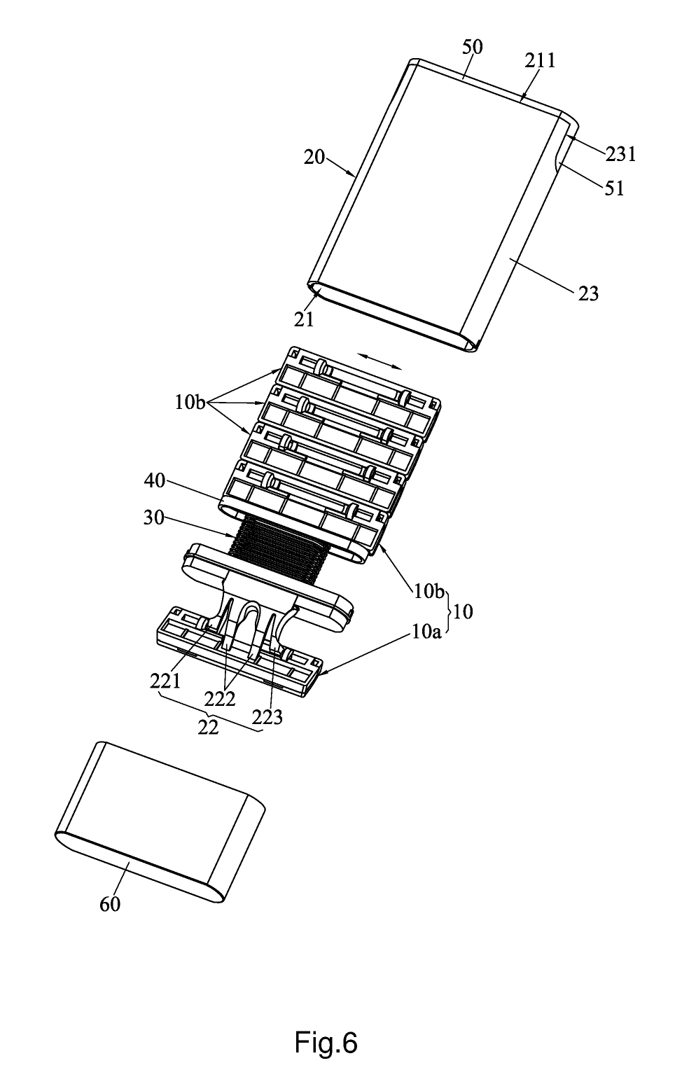

Referring to FIGS. 1-4, a magazine type shaver 100 according to one embodiment of the present invention includes a shaver head assembly 10 (referring to FIG. 6), a magazine body 20 for holding, and an elastic element 30. In this embodiment, the magazine body 20 has a rectangular cross section, and the rectangle structure has smoothing corners to upgrade the magazine body 20 and benefit to steady hold the magazine body 20. In other embodiments, the magazine body 20 may has different shapes. Additionally, the magazine body 20 may use rigid material such as ABS, or elastic material such as PPU, which is not limited.

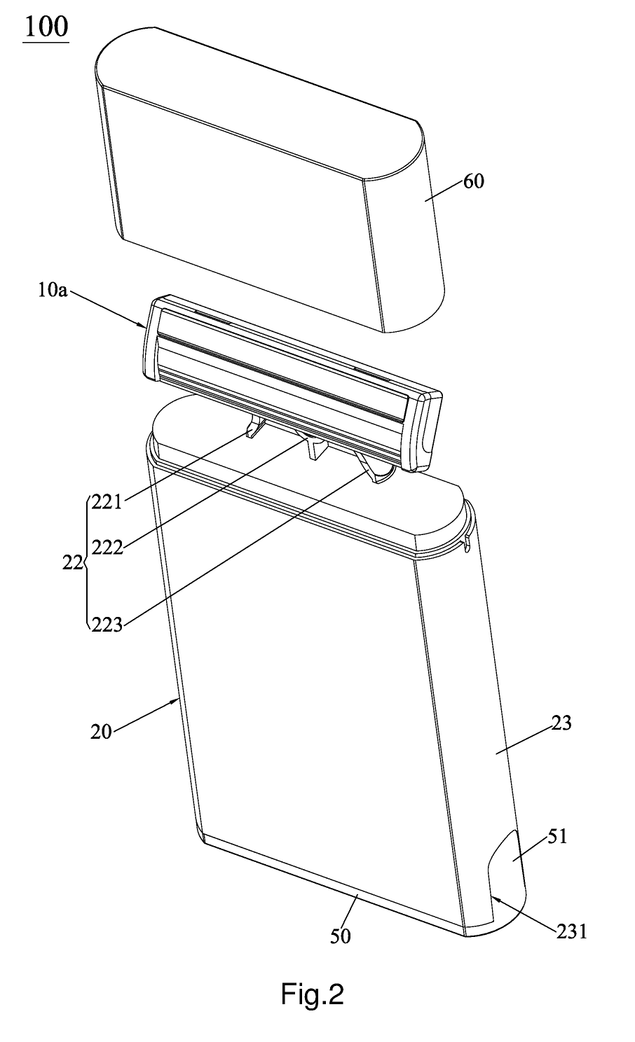

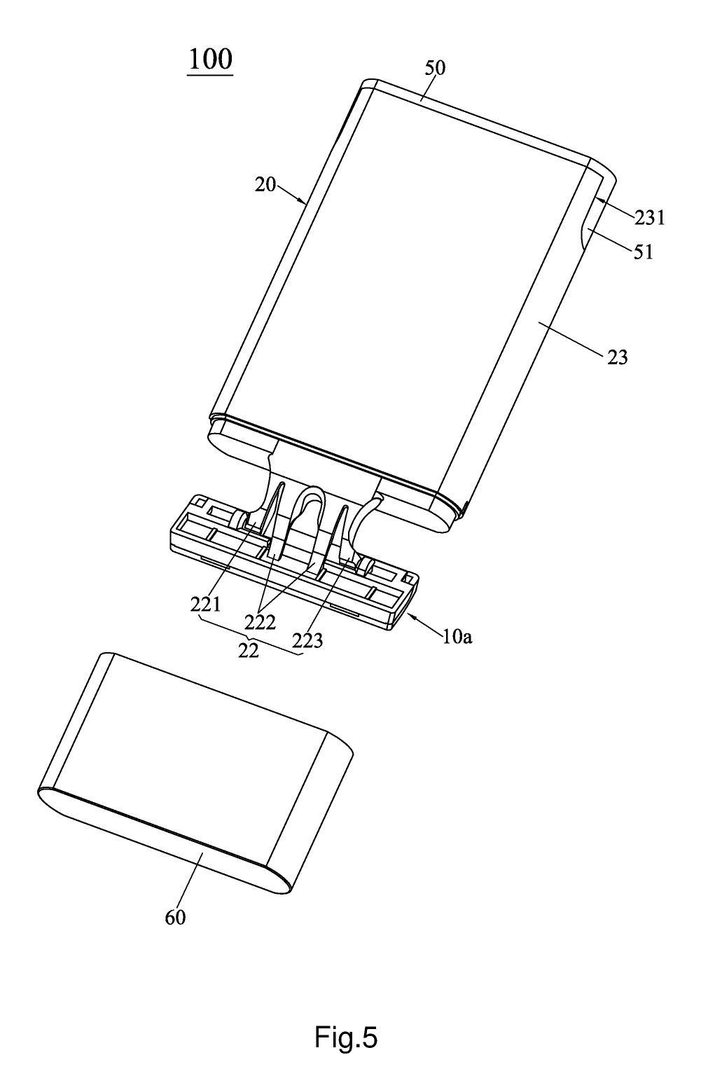

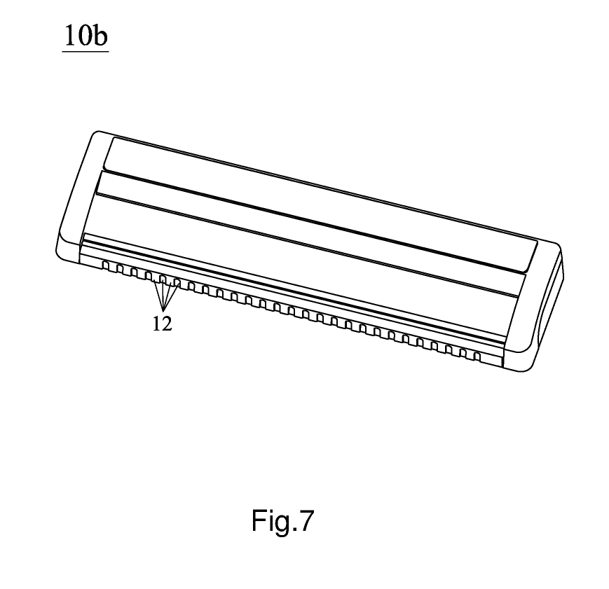

As shown in FIGS. 2-3 and 5-6, the shaver head assembly 10 includes a first shaver head 10a and a second shaver head 10b which are interchangeable, that is, once one of them is blunt or damaged, and the other of them can be replaced. Optionally, the first shaver head 10a and the second shaver head 10b can be in the same type or different types. Specifically, a pushing structure 12 (see FIG. 7) is provided at the side wall of the second shaver head 10b to allow the user to press. The pushing structure 12 is opposite to the under-mentioned cavity opening 211, so that a thumb of user can be pressed on the pushing structure 12 when user's hand holds the magazine body 20. Once a force is applied on the pushing structure 12, the first shaver head 10a or the second shaver head 10b in the receiving chamber 21 will be capable of being slid out of the receiving chamber 21 along a lengthwise direction of the shaver head assembly 10 (namely the double arrow direction in FIG. 6). Preferably, the lengthwise direction of the shaver head assembly 10 is same with the long edge direction of the magazine body 20. Preferably, the pushing structure 12 is a rugged structure to increase friction, thereby removing the first shaver head 10a or the second shaver head 10b from the opening 231. For example, the rugged structure includes a row of dents arranged along the lengthwise direction of the shaver head assembly 10. Furthermore, in other embodiments, the pushing structure 12 can be configured on a front side wall of the first shaver head 10a, or at least one of front side walls of the first shaver head 10a and the second shaver head 10b, which is not limited.

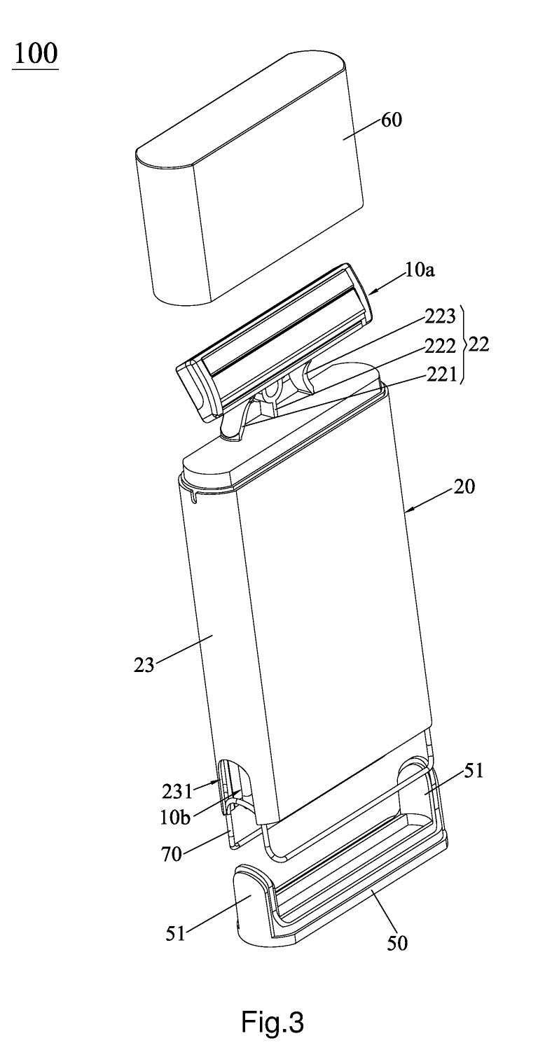

As shown in FIGS. 3 and 6, the magazine body 20 is a hollow structure which forms a receiving chamber 21 with an opening 231 for receiving the first shaver head 10a and the second shaver head 10b. Preferably, the receiving chamber 21 penetrates a lower end of the magazine body 20 along the lengthwise direction of the magazine body 20, and the cavity opening 211 is located at the bottom of the magazine body 20, so that user takes out the first shaver head 10a or the second shaver head 10b from the receiving chamber 21. Because the shaver heads is accommodated in the receiving chamber 21, thus the shaver heads can be protected and convenient to carry. Specifically, the magazine body 20 has a connection part 22 located at the top surface of the magazine body 20, and selectively assembled with the first shaver head 10a or the second shaver head 10b. Preferably, the connection part 22 is detachably connected to the first shaver head 10a or the second shaver head 10b, so that the shaver head can be replaceable.

As shown in FIG. 6, the elastic element 30 is accommodated in the receiving chamber 21 and urges the shaver heads that are received in the receiving chamber 21 to slide towards the opening 231, so that user can press the pushing structure 12 to take out the first shaver head 10a or the second shaver head 10b from the opening 231. In this embodiment, the elastic element 30 is located at the top of the shaver heads received in the receiving chamber 21, thus the elastic element 30 urges the shaver heads to slide downwards to the opening 231. Preferably, the first shaver head 10a or the second shaver head 10b is taken out by firstly steady holding the magazine body 20 by a hand and pressing the thumb on the first shaver head 10a or the second shaver head 10b near the cavity opening 211, then applying force to the corresponding shaver head along the lengthwise direction (that is the double arrow direction in FIG. 6) of the shaver head assembly 10 to push the shaver head, in such a way, so the first shaver head 10a or the second shaver head 10b can be slid out of the opening 231.

For improving a pushing effect of the elastic element 30, a pushing plate 40 is arranged in the receiving chamber 21 and has an adaptive size with the inner wall of the receiving chamber 21, so that the pushing plate 40 can be slid more smoothly. Specifically, the pushing plate 40 is located at the top of the shaver heads inside the receiving chamber 21, thus the pushing plate 40 urges the shaver heads to slide downwards. The upper end of the pushing plate 40 is elastically contacted with the elastic element 30, and the lower end of the pushing plate 40 is contacted with the first shaver head 10a or the second shaver head 10b accommodated in the receiving chamber 21. Under the spring action of the elastic element 30, the pushing plate 40 maintains to push that shaver heads accommodated in the receiving chamber 21 downwards to the opening 231. By means of the pushing plate 40, the pushing action of the elastic element 30 is more reliable, and the shaver heads in the chamber 21 can be stacked reliably. Preferably, the elastic element 30 is a telescopic spring.

More specifically, referring to FIGS. 2-3 and 5-6, the connection part 22 includes a support arm extending from the upper end of the magazine body 20 and an abutment arm 222 that is elastic. The support arm is selectively and detachably assembled with the first shaver head 10a or the second shaver head 10b; and the abutment arm 222 is elastically pressed on the first shaver head 10a or the second shaver head 10b that is assembled with the support arm, thus the contact between the shaver head 10a or 10b and the skin is more reliable, due to the elastic pushing force. Preferably, a curved first support arm 221 and a curved second support arm 223 in this embodiment are provided and spaced apart from each other, and the abutment arm 222 is located between the first support arm 221 and the second support arm 223, so that the shaver head 10a or 10b can be assembled on the support arms reliably, and the contact force on the shaver head 10a or 10b is even and reliable. Preferably, the abutment arms 222 are arranged in pairs, but not limited to it.

Referring to FIG. 6, multiple second shaver heads 10b are arranged and stacked in the vertical direction. Specifically, in this embodiment, the amount of the second shaver heads 10b is four, but other amounts can be arranged, according to the actual demands and actual design. Specifically, each pushing structure 12 for each the second shaver head 10b is arranged downwards.

Referring to FIGS. 1-6, the magazine type shaver 100 further includes a shielding cover 50. Preferably, the shielding cover 50 is detachably assembled to the lower end of the magazine body 20 so that the shielding cover 50 covers the cavity opening 211 to protect the shaver heads in the receiving chamber 21. Preferably, the opening 231 is located at the side wall 23 of the magazine body 20, such as the left or right side walls 23 of the magazine body 20 shown in FIG. 6, but not limited thereto. Preferably, the opening 231 is located at the lower ends of the left and right side walls 23 of the magazine body 20, but not limited to it. As shown in FIG. 3, the opening 231 also penetrates through the cavity opening 211, so that the first shaver head 10a or the second shaver head 10b in the receiving chamber 21 can be slid from the left side to the right side when the pushing structure 12 is pressed. Specifically, the shielding cover 50 further is provided with a plug-in part 51 inserted in the opening 231, so that the shielding cover 50 can be more reliably installed and dismounted from the lower end of the magazine body 20. For making the shaver 100 waterproof, a sealing strip 70 is arranged between lower ends of the magazine body 20 and the shielding cover 50. The sealing strip 70 seals a joint of the lower end of the magazine body 20 and the shielding cover 50, effectively preventing water from entering the receiving chamber 21.

The magazine type shaver 100 further includes a protective case 60 assembled on a top end of the magazine body 20. Preferably, the protective case 60 is detachably assembled on the upper end of the magazine body 20, so as to cover the connection part 22, and the first shaver head 10a or the second shaver head 10b that is assembled with the connection part 22. Specifically, a box structure is defined by the protective case 70 and the magazine body 20, more preferably, the box structure is a rectangular structure including two curved short edges and two straight long edges. Due to the protective case 70, the first shaver head 10a or the second shaver 10b connected to the connection part 22 is unnecessary to be accommodated in the receiving chamber 21, instead is accommodated in the protective case 70, thus more replaceable shaver heads can be accommodated in the receiving chamber 21.

In comparison with the prior art, since the shaver heads is accommodated in the receiving chamber 21 of the magazine body 20 and urged to slide to the opening 231 under an action of the elastic element 30, and the connection part 22 is selectively assembled with the first shaver head 10a or the second shaver head 10b. Thus the magazine body 20 has compact structure and clean look. Further, the replaceable shaver head is accommodated in the magazine body 20, thus the replaceable shaver head is not easy to be omitted and is convenient to be carried. Furthermore, the shaver heads in the receiving chamber 21 is urged to slide upwards due to the spring action of the elastic element 30, thus it's easy and convenient for user to expose the opening 231 and then take out a replaceable shaver head from the receiving chamber 21.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A magazine type shaver, comprising:
a shaver head assembly, comprising a first shaver head and a second shaver head which are interchangeable;
a magazine body for holding, the magazine body being a hollow structure which forms a receiving chamber with an opening for receiving the first shaver head and the second shaver head, and the magazine body being provided with a connection part selectively assembled with the first shaver head or the second shaver head; and
an elastic element, accommodated in the receiving chamber and urging the shaver heads received in receiving chamber to slide towards the opening.

2. The magazine type shaver according to claim 1, further comprising a pushing plate accommodated in the receiving chamber, one end of the pushing plate contacting with the elastic element, and the other end of the pushing plate contacting with the shaver heads that are received in the receiving chamber.

3. The magazine type shaver according to claim 1, wherein a plurality of the second shaver heads are provided and arranged along a lengthwise direction of the magazine body.

4. The magazine type shaver according to claim 1, wherein the connection part is located at a top surface of the magazine body.

5. The magazine type shaver according to claim 1, wherein the connection part comprises a support arm extending from the top surface of the magazine body and an abutment arm that is elastic, the support arm is selectively assembled with the first shaver head or the second shaver head, and the abutment arm abuts on the first shaver head or the second shaver head that is assembled with the support arm.

6. The magazine type shaver according to claim 5, wherein the support arm comprises a curved first support arm and a curved second support arm spaced apart from each other, and the abutment arm is located between the first support arm and the second support arm.

7. The magazine type shaver according to claim 1, wherein the opening is formed at a side wall of the magazine body.

8. The magazine type shaver according to claim 7, wherein the receiving chamber penetrates a lower end of the magazine body and forms a cavity opening, the lower end of the magazine body is provided with a shielding cover to cover the cavity opening, and the shielding cover further is provided with a plug-in part inserted in the opening.

9. The magazine type shaver according to claim 8, wherein a sealing strip is provided between the lower end of the magazine body and the shielding cover, and the sealing strip seals a joint of the lower end of the magazine body and the shielding cover.

10. The magazine type shaver according to claim 1, further comprising a protective case assembled on an upper end of the magazine body for covering the connection part, and the first shaver head or the second shaver head that is assembled with connection part, and a box structure being defined by the protective case and the magazine body.

11. A magazine type shaver, comprising:
a shaver head assembly, comprising a first shaver head and a second shaver head which are interchangeable, the first shaver head and the second shaver head being provided with a pushing structure;
a magazine body for holding, the magazine body being a hollow structure which forms a receiving chamber with an opening for receiving the first shaver head and the second shaver head, and the magazine body being provided with a connection part selectively assembled with the first shaver head or the second shaver head; and
an elastic element, accommodated in the receiving chamber and urging the shaver heads received in receiving chamber to slide towards the opening, and the first shaver head or the second shaver head received in receiving chamber being capable of being slid out of the opening by pressing the pushing structure.

12. The magazine type shaver according to claim 11, wherein the pushing structure is a rugged structure.
